(19) United States
(12) Patent Application Publication
(10) Pub. No.: US 2015/0187027 A1
(43) Pub. Date: Jul. 2, 2015

(54) SYSTEM FOR CONTROLLING PRODUCTION OF FOOD PRODUCTS

(71) Applicant: ISPORT MARKETING PTY LTD, Castle Hill, NSW (AU)

(72) Inventor: Ian John Lowe, Castle Hill (AU)

(21) Appl. No.: 14/410,950

(22) PCT Filed: Jun. 26, 2013
(86) PCT No.: PCT/AU2013/000691

§ 371 Date: Dec. 23, 2014

(30) Foreign Application Priority Data
Jun. 26, 2012 (AU) 2012902714

(51) Int. Cl. G06Q 50/12; G06Q 10/06

(52) U.S. Cl. CPC G06Q 50/12; G06Q 10/0633

(57) ABSTRACT

A method of controlling ordering and production of food products in a restaurant, constructing a composite queue from time slots associated with customers standing physical lines to place their orders at manual registers, and time slots associated with customers placing their orders electronically over a communications network, determining, in regard to a current order load states of at least some cooking areas in a kitchen, determining whether one of the load states varies from a pre-determined load state by a first threshold amount, and if so determining an increment to the service delay for the current order, and communicating information about the increment to the customer being served.

### TECHNICAL FIELD

The present invention relates generally to controlling food production in restaurants, and in particular, controlling food production in restaurants having a very high volume of customers. The present invention also relates to a method and apparatus for controlling food production in restaurants, and to a computer program product including a computer readable medium having recorded thereon a computer program for controlling food production in restaurants.

### BACKGROUND

Many restaurants, especially those in clubs and pubs where there is a high volume of customers, use a simple queuing system at single or multiple manual registers to take orders for food, which is then delivered to tables or picked up from a food assembly area by the customers in question.

When such venues are busy, the queue or queues can be quite long, and customers can experience large delays in placing their orders. This often results in lost orders because customers become impatient and leave the venue. Customers also become irritable when unexplained delays occur, and this causes distress to both the customers and the staff with whom they come into contact.

The aforementioned phenomena occur in the “front of house” where this phrase in a restaurant refers to the area and people you can see on your average visit. The front of house thus includes, for example, the operators of the manual registers, waiters providing table service, wine waiters and so on.

Behind the scenes, i.e., in the “back of house” which includes the kitchens and behind the scenes staff who support operation of such restaurants, kitchen capacity may become overloaded if the speed of orders sent through from the front of house exceeds the speed at which food can be prepared in the kitchens. Such overload conditions can be effected by the speed in which orders are taken in the front of house, the types of food which are ordered (e.g., steaks take much longer to cook than omelettes), and the time it takes to cook any particular meal or group of meals, since it is always desirable to produce all meals in a particular order at the same time.

### SUMMARY

It is an object of the present invention to substantially overcome, or at least ameliorate, one or more disadvantages of existing arrangements.

Disclosed are arrangements, referred to as Composite Queuing and Control (CQC) arrangements which seek to address the above problems by enabling customers entering the restaurant to either stand in a physical queue, or self-order their meal using a smartphone, tablet or similar device, referred to hereinafter as a “smartphone”, ensuring fairness by constructing a composite queue which prevents or at least reduces queue jumping and other socially undesirable queuing habits—this is referred to as process 1.

The CQC arrangements can also advise self-ordering customers of the expected total time for their orders to be ready—this is referred to as process 2.

The CQC arrangements can also determine the occurrence of congestion in the back of house, and in response thereto, advise both self-ordering customers, and customers standing in physical queues, about impending delays, thus keeping them informed and consequently reducing the irritation otherwise caused—this is referred to as process 3.

The CQC arrangements can also adjust the front of house order processing speed to accommodate the capacity of the kitchen, thus enabling a more efficient operation—this is referred to as process 4.

The various processes 1-4 referred to above can be performed manually, based upon the skill and experience of staff such as a Sous Chef (in the “back of house”) and/or a Maitre De (in the “front of house”), or alternately can incorporate various amounts of automation, to assist the aforementioned staff or to replace certain functions otherwise performed by them, or alternately can be fully or almost fully automated, all these alternatives falling within the scope of the disclosed CQC arrangement.

According to a first aspect of the present invention, there is provided a method of controlling ordering and production of food products in a restaurant, the method comprising the steps of:
constructing a composite queue from:
   time slots associated with customers standing in one or more physical lines to place their orders at one or more corresponding manual registers; and
   time slots associated with customers placing their orders electronically over a communications network; wherein the time slots in the composite queue are spaced apart by a speed of service delay;
determining, in regard to a current order received from a customer being served from the composite queue, load states of at least some cooking areas in a kitchen;
determining whether one of said load states varies from a pre-determined load state by a first threshold amount;
if said one of the load states varies from the pre-determined load state by the first threshold amount, determining an increment to the speed of service delay for the current order; and
communicating information about said increment to the customer being served.

According to another aspect of the present invention, there is provided a computer implemented system for controlling ordering and production of food products in a restaurant, the system comprising:
a server having a processor;
a memory storing a program for directing the processor to execute a method for controlling ordering and production of food products in the restaurant, the method comprising the steps of:
constructing a composite queue from:
   time slots associated with customers standing in one or more physical lines to place their orders at one or more corresponding manual registers; and
   time slots associated with customers placing their orders electronically over a communications network;
determining, in regard to a current order received by a server from a customer being served from the composite queue, load states of at least some cooking areas in a kitchen;
determining whether one of said load states varies from a pre-determined load state by a first threshold amount; and
if said one of the load states varies from the pre-determined load state by the first threshold amount, determining an increment to the service delay for the current order, and communicating information about said increment the customer being served.

According to another aspect of the present invention, there is provided a server for a computer implemented system for of controlling ordering and production of food products in a restaurant, the server comprising:
a processor;
a memory storing a program for directing the processor to execute a method for controlling ordering and production of food products in the restaurant, the method comprising the steps of:
constructing a composite queue from:
   time slots associated with customers standing in one or more physical lines to place their orders at one or more corresponding manual registers; and
   time slots associated with customers placing their orders electronically over a communications network;
determining, in regard to a current order received by a server from a customer being served from the composite queue, load states of at least some cooking areas in a kitchen;
determining whether one of said load states varies from a pre-determined load state by a first threshold amount; and
if said one of the load states varies from the pre-determined load state by the first threshold amount, determining an increment to the service delay for the current order, and communicating information about said increment the customer being served.

According to another aspect of the present invention, there is provided a non-transitory computer readable storage medium storing a computer executable software program for directing a processor to execute a method for controlling ordering and production of food products in a restaurant, the program comprising:
computer executable code for constructing a composite queue from:
   time slots associated with customers standing in one or more physical lines to place their orders at one or more corresponding manual registers; and
   time slots associated with customers placing their orders electronically over a communications network;
computer executable code for determining, in regard to a current order received by a server from a customer being served from the composite queue, load states of at least some cooking areas in a kitchen;
computer executable code for determining whether one of said load states varies from a pre-determined load state by a first threshold amount; and
computer executable code for, if said one of the load states varies from the pre-determined load state by the first threshold amount, determining an increment to the service delay for the current order, and communicating information about said increment the customer being served.

Other aspects of the invention are also disclosed.

### BRIEF DESCRIPTION OF THE DRAWINGS

At least one embodiment of the present invention will now be described with reference to the drawings, in which:

FIG. 1 depicts a restaurant in which the disclosed CQC arrangements can be performed;

FIGS. 2A and 2B form a schematic block diagram of a general purpose computer system upon which described CQC arrangements can be practiced;

FIG. 3 shows a flowchart of a CQC process example from the perspective of a customer such as 126 in FIG. 1;

FIG. 4 depicts two “back of house’ processes which interact in an ongoing manner in the CQC arrangement;

FIG. 5 illustrates how the composite queue may be formed from customers standing in a physical line and in a virtual queue;

FIG. 6 shows a pictorial example of the composite queue of FIG. 5 after the self ordering customer has been integrated;

FIG. 7 depicts the composite queue some time later when the first customer P₁ in FIGS. 5 and 6 has been served;

FIG. 8 shows a flowchart for an example process for constructing the composite queue depicted in FIGS. 5-7;

FIG. 9 shows a flowchart for a back of house food production process example;

FIG. 10 shows a flowchart for an example process for adjusting front of house service processes; and

FIG. 11 shows a flowchart for another example process for constructing the composite queue.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and the section above relating to prior art arrangements relate to discussions of arrangements which may form public knowledge through their use. Such discussions should not be interpreted as a representation by the present inventor or the patent applicant that such documents or devices in any way form part of the common general knowledge in the art.

### GLOSSARY OF PARAMETERS

d_{sq} estimated time to service until an order is ready to consume:
dₛₛ speed of service delay ie spacing between customers in the composite queue
d_{order}ⁱ a cooking delay parameter for an order which arises from a congestion at a cooking area no i for an item in the order, so that the cooking time for that order is longer than the normal cooking time for the longest cook time item in the order
d_{pq} time that the physical queue customer will stand in the queue
d_{cq} current total composite queue delay which is the delay that a customer allocated to the last active timeslot in the composite queue can expect before his or her order will either (a) be taken by the manual register if the customer is standing in the physical line, or (b) sent to the kitchen if the order was placed electronically
dₚₒ time taken by physical queue customer to convey order to the staff member manning the manual register
d_{c} time taken for order to be prepared in the kitchen (includes d_{order})
d_{c}ⁱ time taken for order no. i to be prepared in the kitchen
dᵥₒ time to place an order by smartphone (self-order)
d_{vq} delay incurred in waiting in the virtual queue
Pᵢ physical customer no. i located in the composite queue
V₁ self ordering customer no. i located in the composite queue
dᵥₜ time between orders
C_{aq}ⁱ number of orders being cooked on the ith cooking area
Sᵢ the ith service-register
r a service register number reduction factor
Cₐⁱ the ith cooking areas
C_{aq}^{max} the maximum number of items a cooking area can accommodate
Cₚ the average percentage of all orders that each area has placed on it
Cₑₜⁱ the time item no. i has been cooking (the elapsed time)
Cₑₜⁱ⁺¹ the time that is needed for a space to be available to begin cooking the current last item+1 in the cooking queue Cₐ.

Disclosed are arrangements, referred to as Composite Queuing and Control (CQC) arrangements which seek to address the above problems by enabling customers to entering the restaurant to either stand in a physical queue, or self-order their meal using a smartphone, tablet or similar device, referred to hereinafter as a “smartphone”, ensuring fairness by constructing a composite queue which prevents or at least reduces queue jumping and other socially undesirable queuing habits—this is referred to as process 1.

The CQC arrangements can also advise self-ordering customers of the expected total time for their orders to be ready—this is referred to as process 2.

The CQC arrangements can also determine the occurrence of congestion in the back of house, and in response thereto, advise both self-ordering customers, and customers standing in physical queues, about impending delays, thus keeping them informed and consequently reducing the irritation otherwise caused—this is referred to as process 3.

The CQC arrangements can also adjust the front of house order processing speed to accommodate the capacity of the kitchen, thus enabling a more efficient operation—this is referred to as process 4.

The various processes 1-4 referred to above can be performed manually, based upon the skill and experience of staff such as BoH a Sous Chef (in the “back of house”) and/or a Maitre De (in the “front of house”), or alternately can incorporate various amounts of automation, or alternately can be fully or almost fully automated, all these alternatives falling within the scope of the disclosed CQC arrangement.

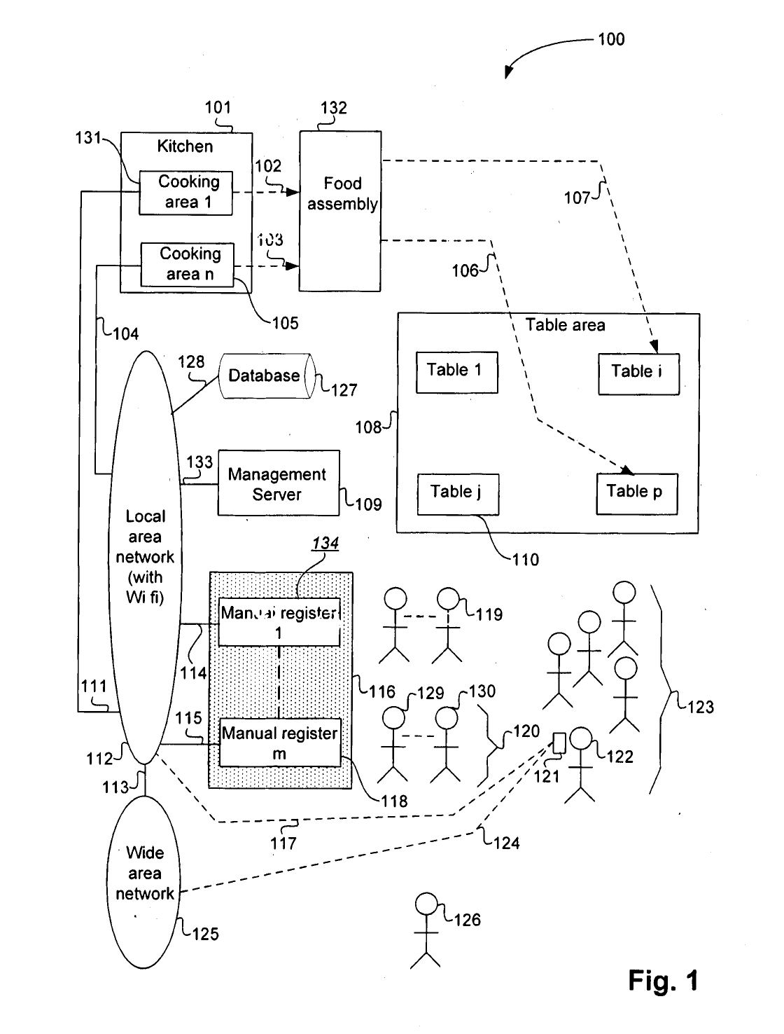

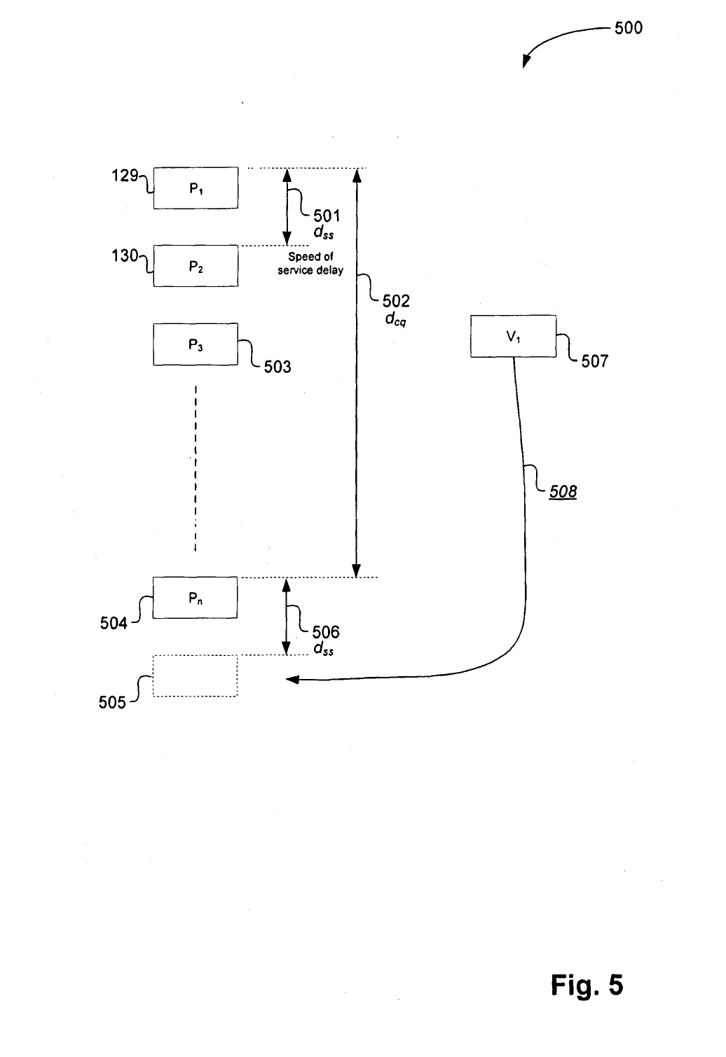

The CQC arrangement reduces queuing delays and simplifies current order processes by providing a service that allows customers, as an alternative to standing in a physical line or waiting at a table in a restaurant for service, to self order through a smartphone application or web site (eg see a customer 122 in FIG. 1 using their smartphone 121 to self-order). The CQC arrangements provide a virtual front of house in regard to the self-order customers, which allocates customers to time slots in a composite queue according to a set of timing parameters determined by the operational processes (such as the kitchen 101 in FIG. 1) in the front and back of house. Various examples for constructing the composite queue are described in FIGS. 5-8 and 11.

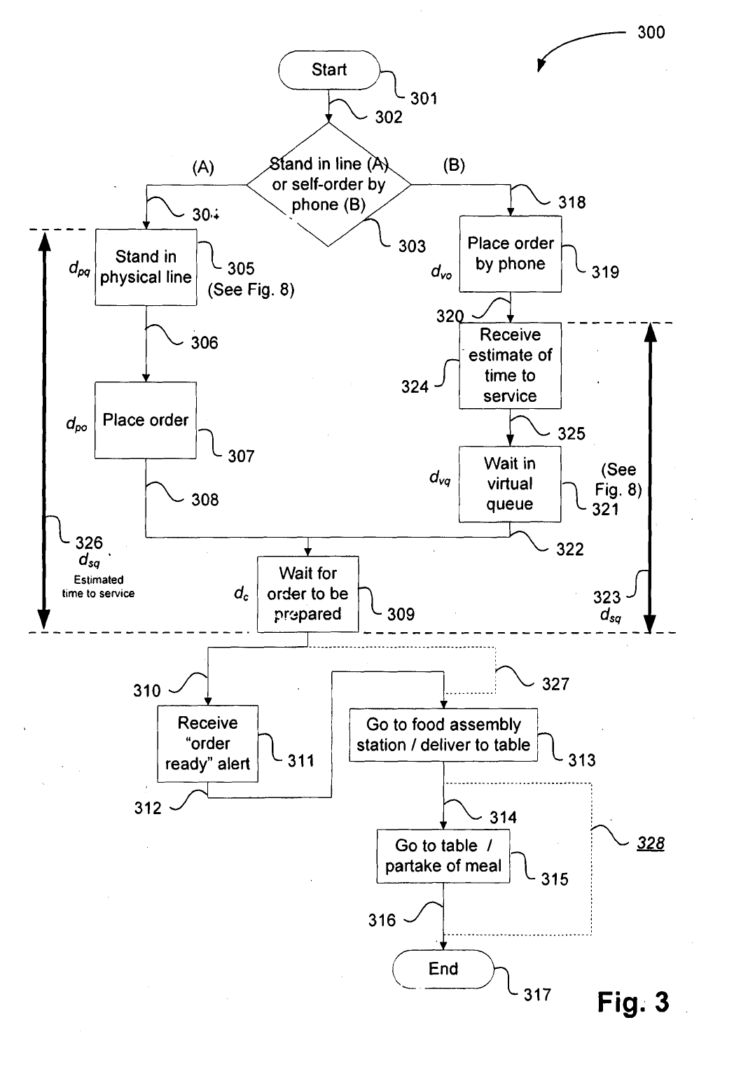

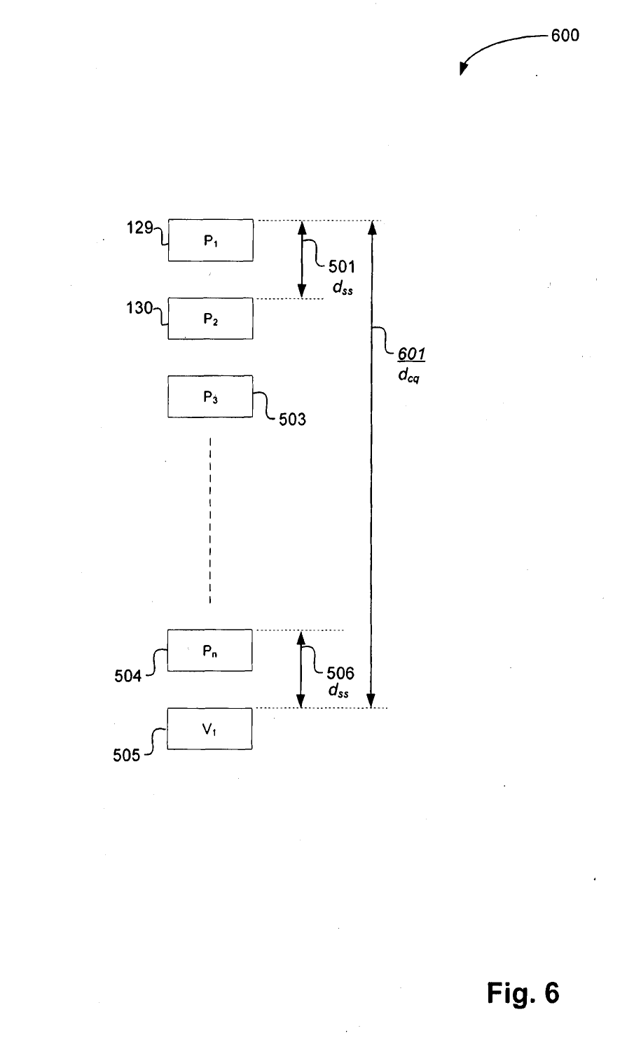

When creating the composite queue the CQC arrangement advises the self-ordering customer of the estimated time to service d_{sq} (see 323 in FIG. 3). The Estimated Time to Service d_{sq} is the estimated time until the food will be delivered to the self-ordering customer's table, or is made available for him for pick up at the food assembly area 132. This parameter d_{sq} is dependent upon the sum of all processes for an item in the order that has the longest queue time. The CQC arrangement prevents overloading of the production area, and an important element in achieving this is derivation of the Standard Service Time parameter dₛₛ, also referred to as a speed of service parameter or speed of service delay (see 501 in FIG. 6).

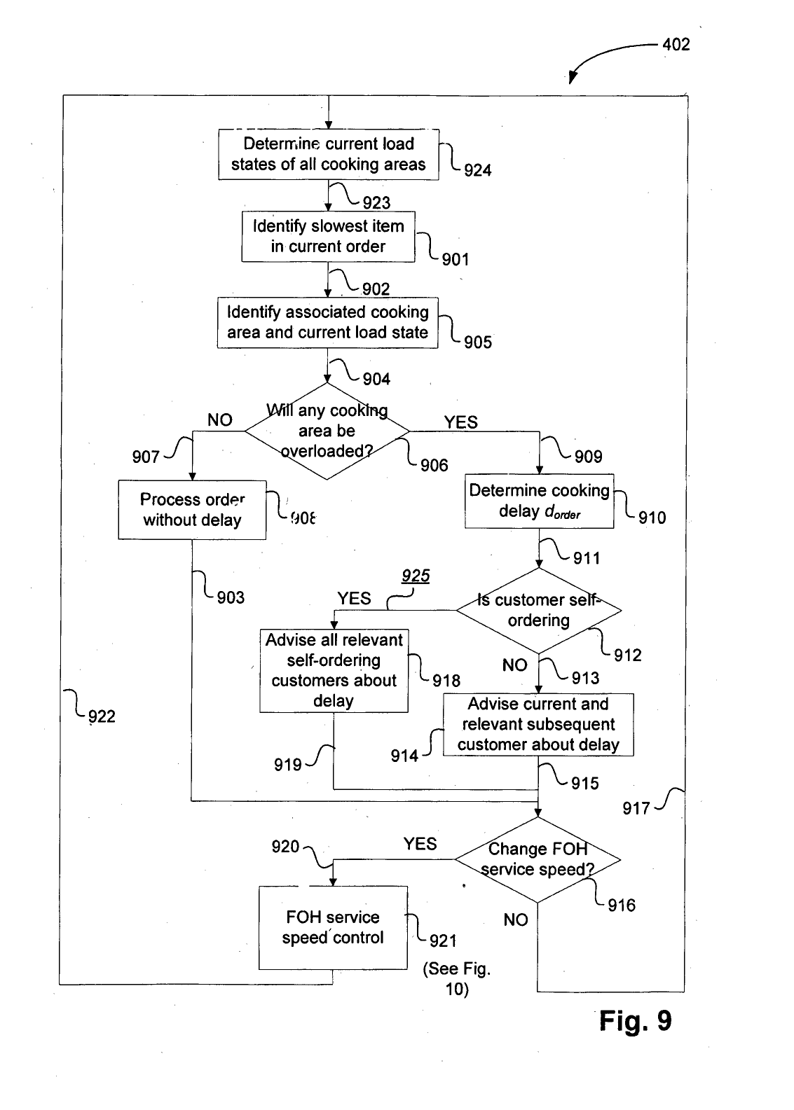

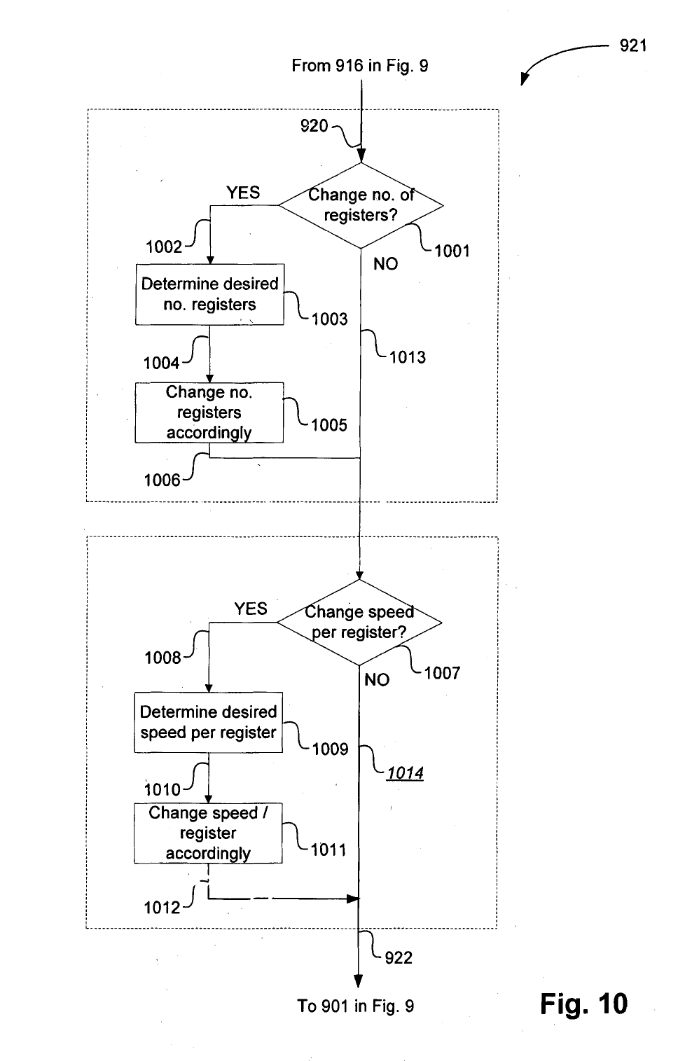

Once an order is placed (see 307 and 319 in FIG. 3) the likelihood of a major delay occurring is relatively slight. Self-ordering customers are advised of the estimated time to service d_{sq} and this creates an expectation. This expectation is managed by notifying the self-ordering customer of any expected delay (see 918 in FIG. 9) as soon as possible.

Physical line customers ie those who elect to stand in a physical queue such as 120 in FIG. 1, are not advised of the estimated time to service d_{sq}. They are however notified of delays which might arise in back of house (see d_{order} and a step 914 in FIG. 9).

Unless otherwise noted, the term front of house is used throughout this description to include both the traditional front of house elements (such as waiters) and the virtual front of house elements, comprising the CQC elements associated with the front of house issues such as speed of processing food orders.

The composite queue pieces self-order customers in the queue by setting a time based positional parameter controlled either manually by a restaurant manager, or automatically by a queue server, or in a hybrid manual/automated manner depending upon the degree of automation used. The CQC arrangement creates controls for the production of food in order to reduce or eliminate overloading of the production area by controlling the speed at which orders are received and processed in the front of house.

The CQC arrangement assesses the speed at which all meals in a single order can be cooked based on the slowest item in the order, and caters for capacity limitations in production areas by placing delays on orders based, for example, on parameters set by the Sous Chef for each cooking area (eg 105 in FIG. 1).

In a manual CQC arrangement, slider based controls (not shown) can be manually set by cooking area based on the operational capacity of any area, be that based upon physical space limitations or the skill of the cooks. Alternately, automated CQC arrangements catering only to self-ordering customers will eliminate many or most timing uncertainties. This may occur in some circumstances, such as say a football stadium with a dedicated service portal for Electronic orders. Partially automated CQC arrangements can also be implemented.

FIG. 1 depicts a restaurant 100 in which the disclosed CQC arrangements can be performed. The restaurant 100 has, in the front of house, a table area 108 containing a number of tables such as 110 at which customers can sit and eat their meals, once these have been prepared. A set 116 of manual registers such as 118 are available at which customers can stand in line in order to place their orders. As an alternative to the physical queuing option, customers can place their orders via a software application running on their smartphone, as depicted by the customer 122. A food assembly area 132 is used to assemble and present food for the customers once the food has been prepared in the kitchen 101. Food is delivered to the customers table 110 or customers can remove their food from the food assembly area 132 and walk to tables in the table area 108 in order to eat their meals.

For restaurants and larger operations, the CQC arrangements enable table service to be provided at lower cost (because of staff reductions arising from use of the CQC arrangement) thus providing customers with the feeling of full restaurant service.

In the example depicted in FIG. 1, the queue management server 109 can communicate with a database 127 which is connected to a local area network 112 as depicted by connections 128 and 133. The manual register 118 is connected, as depicted by a connection 115, to the local area network 112. The cooking area 105 in the kitchen 101 is connected, as depicted by a connection 104, to the local area network 112. A wide area network 125, such as the Internet, is connected, as depicted by a connection 113, to the local area network 112. The customer 122 is able, by means of her smartphone 121, to communicate, as depicted by a dashed line 124, with the wide area network 125 and from there via the connection 113 and the local area network 112 to the queue management server 109. Alternatively, the customer 122 can communicate as depicted by a dashed line 117 directly with the local area network 112 and from there via the connection 133 to the management server 109.

The CQC arrangement in FIG. 1 enables a new customer 126 to choose one of a number of different queuing options upon entering the restaurant, namely a physical queuing system as depicted by a queue 120 of timeslots 129 and 130 associated with respective customers, or a virtual queuing system as depicted by the customer 122 using her smart phone 121. As described hereinafter in more detail in regard to FIGS. 5-8, a CQC software application program 233 ensures that the physical queue and the virtual queue are merged into a composite queue which does not enable any customer to “jump the queue” and provides a fair mechanism for all customers whether they choose the physical or virtual queuing mechanism. The CQC arrangements therefore, when merging the virtual queue and the physical queue to form the composite queue, allow for real world processes and ethics to be applied.

The CQC arrangement also ensures, as described hereinafter in more detail in regard to FIGS. 9 and 10, that self-ordering customers are notified of the estimated time to service d_{sq} (ie the time to receive their order) when their order is placed (see 324 in FIG. 3). If delays occur these usually occur in the back of house areas such as the kitchen 101.

Furthermore, the CQC arrangement implements a feedback control arrangement whereby the speed at which orders are processed in the front of house is controlled, depending upon load conditions in the back of house. Thus, for example, if congestion is encountered in the back of house, particularly in the kitchen 101, the CQC arrangement can also instruct staff manning the manual registers such as 118 to slow down their rate of taking orders from customers. Although at first sight this may appear to be a potential irritant to customers, the CQC arrangement presumes that smooth operation of food production, coupled with timely information provided to customers about delays and the reasons therefore, will produce a more efficient and friendly environment in the restaurant 100.

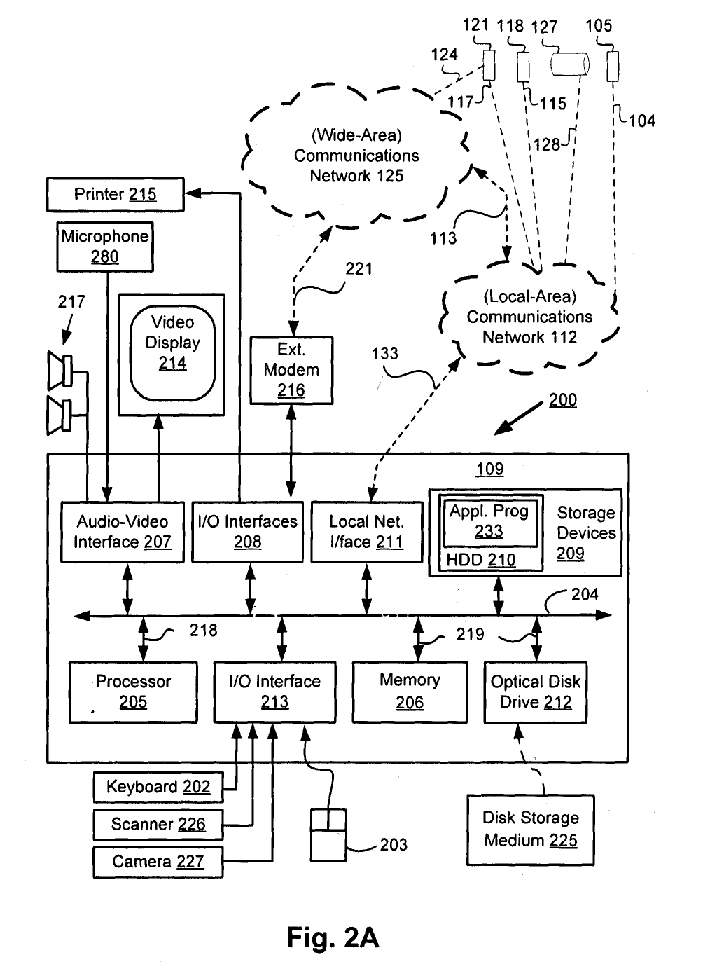

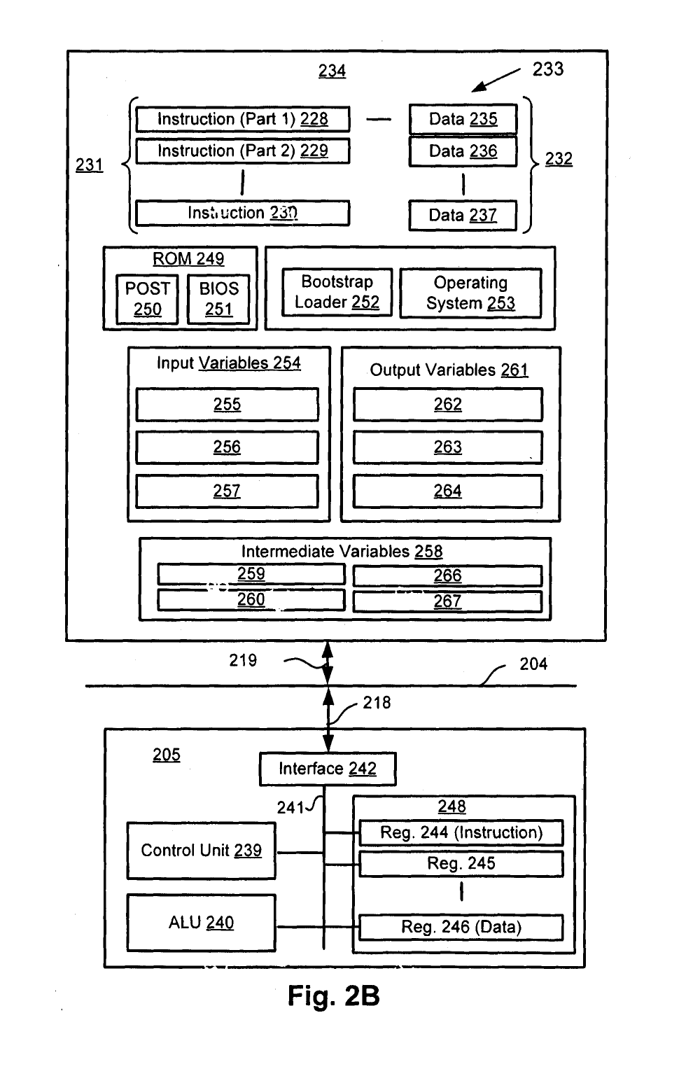

FIGS. 2A and 2B depict a general-purpose computer system 200, upon which the various CQC arrangements described can be practiced. The following sections describe the queuing server (also referred to as a management server) 109 in some detail. It is noted that other CQC system modules such as the smartphone 121 used by the customer 122 to self-order, the register 118, the database 127, and the cooking area 105 also can incorporate embedded computer modules with similar structural and functional elements and capabilities.

As seen in FIG. 2A, the computer system 200 includes: the queuing server 109; input devices such as a keyboard 202, a mouse pointer device 203, a scanner 226, a camera 227, and a microphone 280; and output devices including a printer 215, a display device 214 and loudspeakers 217. An external Modulator-Demodulator (Modem) transceiver device 216 may be used by the queuing server 109 for communicating, to and from the communications network 125 via a connection 221. The communications network 125 may be a wide-area network (WAN), such as the Internet, a cellular telecommunications network, or a private WAN. Where the connection 221 is a telephone line, the modem 216 may be a traditional “dial-up” modem. Alternatively, where the connection 221 is a high capacity (e.g., cable) connection, the modem 216 may be a broadband modem. A wireless modem may also be used for wireless connection to the communications network 125.

The queuing server 109 typically includes at least one processor unit 205, and a memory unit 206. For example, the memory unit 206 may have semiconductor random access memory (RAM) and semiconductor read only memory (ROM). The queuing server 109 also includes an number of input/output (I/O) interfaces including: an audio-video interface 207 that couples to the video display 214, loudspeakers 217 and microphone 280; an I/O interface 213 that couples to the keyboard 202, mouse 203, scanner 226, camera 227 and optionally a joystick or other human interface device (not illustrated); and an interface 208 for the external modem 216 and printer 215. In some implementations, the modem 216 may be incorporated within the queuing server 109, for example within the interface 208.

The queuing server 109 also has a local network interface 211, which permits coupling of the computer system 200 via the connection 133 to the local-area communications network 112, known as a Local Area Network (LAN). As illustrated in FIG. 2A, the local communications network 112 may also couple to the wide network 125 via the connection 113, which would typically include a so-called “firewall” device or device of similar functionality. The local network interface 211 may comprise an Ethernet™ circuit card, a Bluetooth™ wireless arrangement or an IEEE 802.11 wireless arrangement; however, numerous other types of interfaces may be practiced for the interface 211. The server 109 can communicate via the connection 133, the LAN 112 and respective connections 117, 115, 128 and 124 respectively with the smartphone 121 used by the customer 122 to self-order, the register 118, the database 127, and the cooking area 105.

The I/O interfaces 208 and 213 may afford either or both of serial and parallel connectivity, the former typically being implemented according to the Universal Serial Bus (USB) standards and having corresponding USB connectors (not illustrated). Storage devices 209 are provided and typically include a hard disk drive (HDD) 210. Other storage devices such as a floppy disk drive and a magnetic tape drive (not illustrated) may also be used. An optical disk drive 212 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 200.

The components 205 to 213 of the queuing server 109 typically communicate via an interconnected bus 234 and in a manner that results in a conventional mode of operation of the computer system 200 known to those in the relevant art. For example, the processor 205 is coupled to the system bus 204 using a connection 218. Likewise, the memory 206 and optical disk drive 212 are coupled to the system bus 204 by connections 219. Examples of computers on which the described arrangements can be practiced include IBM-PC's and compatibles, Sun Sparcstations, Apple Mac™ or a like computer systems.

The CQC method may be implemented using the computer system 200 wherein the processes of FIGS. 3-10, to be described hereinafter in more detail, may be implemented as one or more CQC software application programs 233 executable within the computer system 200. Although the CQC software application program 233 is depicted as running on the server 109, various elements thereof can execute on the register 118, the database 127, and the cooking area 105, for example. Furthermore, one element of the software application program 233 would be implemented as a software application downloaded to and running on the smartphone 121.

In particular, the steps of the CQC method are effected by instructions 231 (see FIG. 2B) in the software 233 that are carried out within the computer system 200. The software instructions 231 may be formed as one or more code modules, each for performing one or more particular tasks. The software may also be divided into two separate parts, in which a first part and the corresponding code modules performs the CQC methods, and a second part and the corresponding code modules manage a user interface between the first part and the user.

The CQC software may be stored in a computer readable medium, including the storage devices described below, for example. The software is loaded into the computer system 200 from the computer readable medium, and then executed by the computer system 200. A computer readable medium having such software or computer program recorded on the computer readable medium is a computer program product. The use of the computer program product in the computer system 200 preferably effects an advantageous apparatus for effecting the CQC arrangement.

The software 233 is typically stored in the HDD 210 or the memory 206. The software is loaded into the computer system 200 from a computer readable medium, and executed by the computer system 200. Thus, for example, the software 233 may be stored on an optically readable disk storage medium (e.g., CD-ROM) 225 that is read by the optical disk drive 212. A computer readable medium having such software or computer program recorded on it is a computer program product. The use of the computer program product in the computer system 200 preferably effects an apparatus for effecting the CQC arrangements.

In some instances, the application programs 233 may be supplied to the user encoded on one or more CD-ROMs 225 and read via the corresponding drive 212, or alternatively may be read by the user from the networks 125 or 112. Still further, the software can also be loaded into the computer system 200 from other computer readable media. Computer readable storage media refers to any non-transitory tangible storage medium that provides recorded instructions and/or data to the computer system 200 for execution and/or processing. Examples of such non-transitory storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the queuing server 109.

Examples of transitory or non-tangible computer readable transmission media that may also participate in the provision of software, application programs, instructions and/or data to the queuing server 109 include radio or infra-red transmission channels as well as a network connection to another computer or networked device, and the Internet or Intranets including e-mail transmissions and information recorded on Websites and the like.

The second part of the CQC application programs 233 and the corresponding code modules mentioned above may be executed to implement one or more graphical user interfaces (GUIs) to be rendered or otherwise represented upon the display 214. Through manipulation of typically the keyboard 202 and the mouse 203, a user of the computer system 200 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 217 and user voice commands input via the microphone 280.

FIG. 2B is a detailed schematic block diagram of the processor 205 and a “memory” 234. The memory 234 represents a logical aggregation of all the memory modules (including the HDD 209 and semiconductor memory 206) that can be accessed by the queuing server 109 in FIG. 2A.

When the queuing server 109 is initially powered up, a power-on self-test (POST) program 250 executes. The POST program 250 is typically stored in a ROM 249 of the semiconductor memory 206 of FIG. 2A. A hardware device such as the ROM 249 storing software is sometimes referred to as firmware. The POST program 250 examines hardware within the queuing server 109 to ensure proper functioning and typically checks the processor 205, the memory 234 (209, 206), and a basic input-output systems software (BIOS) module 251, also typically stored in the ROM 249, for correct operation. Once the POST program 250 has run successfully, the BIOS 251 activates the hard disk drive 210 of FIG. 2A.

Activation of the hard disk drive 210 causes a bootstrap loader program 252 that is resident on the hard disk drive 210 to execute via the processor 205. This loads an operating system 253 into the RAM memory 206, upon which the operating system 253 commences operation. The operating system 253 is a system level application, executable by the processor 205, to fulfil various high level functions, including processor management, memory management, device management, storage management, software application interface, and generic user interface.

The operating system 253 manages the memory 234 (209, 206) to ensure that each process or application running on the queuing server 109 has sufficient memory in which to execute without colliding with memory allocated to another process. Furthermore, the different types of memory available in the system 200 of FIG. 2A must be used properly so that each process can run effectively. Accordingly, the aggregated memory 234 is not intended to illustrate how particular segments of memory are allocated (unless otherwise stated), but rather to provide a general view of the memory accessible by the computer system 200 and how such is used.

As shown in FIG. 2B, the processor 205 includes a number of functional modules including a control unit 239, an arithmetic logic unit (ALU) 240, and a local or internal memory 248, sometimes called a cache memory. The cache memory 248 typically includes a number of storage registers 244-246 in a register section. One or more internal busses 241 functionally interconnect these functional modules. The processor 205 typically also has one or more interfaces 242 for communicating with external devices via the system bus 204, using a connection 218. The memory 234 is coupled to the bus 204 using a connection 219.

The application program 233 includes a sequence of instructions 231 that may include conditional branch and loop instructions. The program 233 may also include data 232 which is used in execution of the program 233. The instructions 231 and the data 232 are stored in memory locations 228, 229, 230 and 235, 236, 237, respectively. Depending upon the relative size of the instructions 231 and the memory locations 228-230, a particular instruction may be stored in a single memory location as depicted by the instruction shown in the memory location 230. Alternately, an instruction may be segmented into a number of parts each of which is stored in a separate memory location, as depicted by the instruction segments shown in the memory locations 228 and 229.

In general, the processor 205 is given a set of instructions which are executed therein. The processor 1105 waits for a subsequent input, to which the processor 205 reacts to by executing another set of instructions. Each input may be provided from one or more of a number of sources, including data generated by one or more of the input devices 202, 203, data received from an external source across one of the networks 125, 202, data retrieved from one of the storage devices 206, 209 or data retrieved from a storage medium 225 inserted into the corresponding reader 212, all depicted in FIG. 2A. The execution of a set of the instructions may in some cases result in output of data. Execution may also involve storing data or variables to the memory 234.

The disclosed CQC arrangements use input variables 254, which are stored in the memory 234 in corresponding memory locations 255, 256, 257. The CQC arrangements produce output variables 261, which are stored in the memory 234 in corresponding memory locations 262, 263, 264. Intermediate variables 258 may be stored in memory locations 259, 260, 266 and 267.

Referring to the processor 205 of FIG. 2B, the registers 244, 245, 246, the arithmetic logic unit (ALU) 240, and the control unit 239 work together to perform sequences of micro-operations needed to perform “fetch, decode, and execute” cycles for every instruction in the instruction set making up the program 233. Each fetch, decode, and execute cycle comprises:
(a) a fetch operation, which fetches or reads an instruction 231 from a memory location 228, 229, 230;
(b) a decode operation in which the control unit 239 determines which instruction has been fetched; and
(c) an execute operation in which the control unit 239 and/or the ALU 240 execute the instruction.

Thereafter, a further fetch, decode, and execute cycle for the next instruction may be executed. Similarly, a store cycle may be performed by which the control unit 239 stores or writes a value to a memory location 232.

Each step or sub-process in the processes of FIGS. 3-10 is associated with one or more segments of the program 233 and is performed by the register section 244, 245, 247, the ALU 240, and the control unit 239 in the processor 205 working together to perform the fetch, decode, and execute cycles for every instruction in the instruction set for the noted segments of the program 233.

The CQC method may alternatively be implemented in dedicated hardware such as one or more gate arrays and/or integrated circuits performing the CQC functions or sub functions. Such dedicated hardware may also include graphic processors, digital signal processors, or one or more microprocessors and associated memories. If gate arrays are used, the process flow charts in FIGS. 3-4 and 8-10 are converted to Hardware Description Language (HDL) form. This HDL description is converted to a device level netlist which is used by a Place and Route (P&R) tool to produce a file which is downloaded to the gate array to program it with the design specified in the HDL description.

FIG. 3 shows a flowchart of a CQC process 300 from the perspective of a customer such as 126 in FIG. 1. The process 300 commences with a step 301 and follows an arrow 302 to a step 303 in which the customer makes a decision as to whether to stand in the physical line 120, or whether to place his order electronically as depicted by the actions of the customer 122 in FIG. 1.

If the customer 126 elects the physical queue option 120 then the process 300 follows an arrow 304 to a step 305 in which the physical queue customer 126 stands in the queue 120. The process 300 follows an arrow 306 to a step 307 in which the physical queue customer 126 places his order when he reaches the front of the queue 120 and communicates his order to the staff member manning the manual register 118. Thereafter after following an arrow 308 to a step 309 the physical queue customer 126 waits for his order to be prepared in the kitchen 101.

The aforementioned steps 305, 307, and 309 are associated with respective delay times, depicted respectively as d_{pq}, dₚₒ, and d_{c}. These parameters represent respectively the time that the physical queue customer will stand in the queue 120 before arriving at the register 118 and being served (d_{pq}), the order placement delay (dₚₒ), being the time taken by the physical queue customer 126 to convey his order to the staff member manning the manual register 118, and the cooking delay (d_{c}), being the time taken for his order to be prepared in the kitchen 101. The cooking delay d_{c} is the time to cook the food plus any delay d_{order} created by a single station that may, in total be longer than the longest items cook time (see a step 910 in FIG. 9).

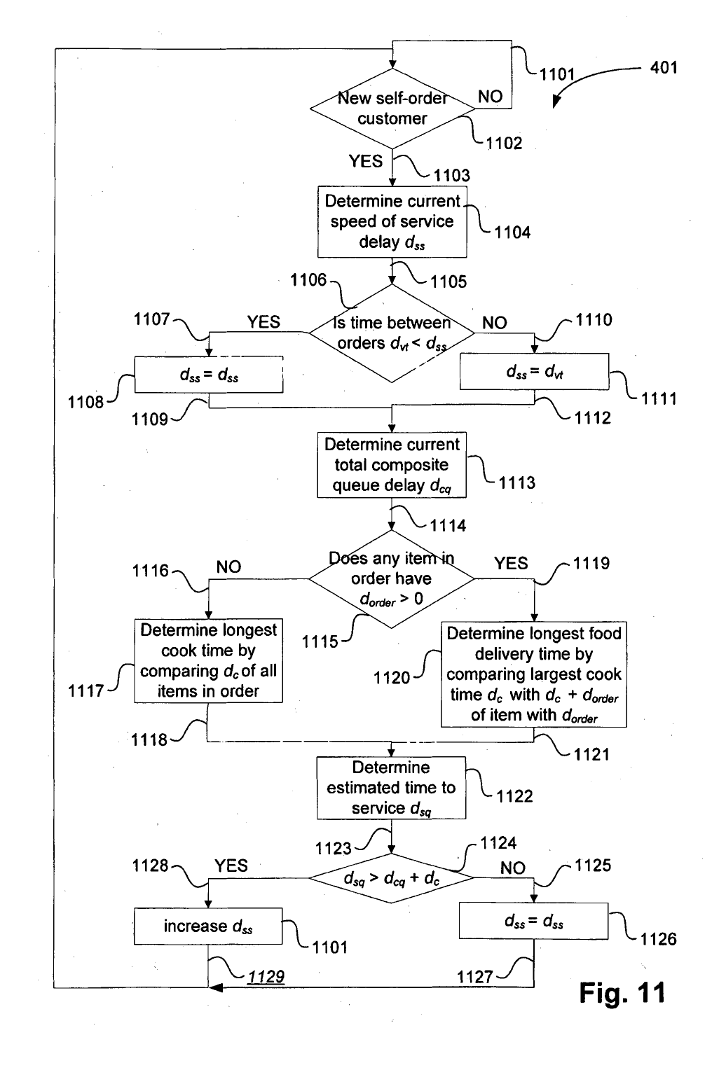

As described hereinafter in more detail in regard to FIG. 11, we consider an example comprising a stir fry order for a cooking area made up of woks, and a medium steak order for a cooking area made up of steak grills. The normal cook time for the stir fry order is designated d_{c}¹ and the normal cook time for a medium steak is designated d_{c}². If for example a wok fails or is overloaded, and consequently a 10 min delay d_{order}¹ is added to stir fry orders, then the resultant stir fry cook time will be longer than that for the medium steak, ie d_{c}¹+d_{order}¹>d_{c}². Accordingly, even though the normal cook time d_{c}² of the steak is normally longer that that d_{c}¹ for a stir fry order, the total time in the kitchen for the delayed stir fry order d_{c}¹=d_{c}¹+d_{order}¹ is the controlling parameter.

The estimated time to service d_{sq} (see 326 in FIG. 3) for the physical queue customer is approximately (allowing for the presence of dₚₒ) equal to the time that the physical queue customer will stand in the queue 120 before arriving at the register 118 and being served d_{pq} plus the cooking delay d_{c}, being the time taken for his order to be prepared in the kitchen 101.

The process 300 then follows an arrow 310 to a step 311 where the food is delivered to the table or in which the physical queue customer receives an “order ready” alert which indicates that his food order has been prepared and is ready for him to collect and consume. This alert may be provided in a number of different ways, either by restaurant staff member calling out the name of the customer or a number which the customer was allocated when he placed his order, or by other equivalent mechanism.

For example in which there is no table service the process 300 follows an arrow 312 to a step 313 in which the physical queue customer goes to the food assembly area 132 to retrieve his meal, after which the process 300 follows an arrow 314 to a step 315 in which the customer goes to the table area 108 to partake of his prepared meal. The process 300 follows an arrow 316 to a step 317 at which point the process terminates. Returning to the step 309, for an example in which there is table service the process 300 follows a dashed arrow 327 to the step 313 in which the meal is delivered to the table where the physical queue customer is waiting, after which the process 300 follows a dashed arrow 328 to the step 317 at which point the process terminates.

Returning to the decision step 303, if the customer 126 decides to place his order by smartphone (ie to self-order), then the process 300 follows an arrow 318 to a step 319 in which the self-order customer places his order by smartphone, as depicted by the dashed lines 117 or 124 in FIG. 1 associated with the self-order customer 122 in FIG. 1. Following an arrow 320, in a following step 324 the self-order customer receives an estimate of the time to service d_{sq}, thus advising him of the expected time until his meal will be ready. Thereafter, after following an arrow 325 to a step 321, the customer waits in the composite queue, probably sitting down at one of the tables such as 110 in the step 309, waiting for his order to be prepared in the kitchen 101.

The process 300 then follows an arrow 310 to a step 311 where the food is delivered to the table or in which the self order customer receives an “order ready” alert which indicates that his food order has been prepared and is ready for him to collect and consume. This alert may be provided in a number of different ways, either by a direct electronic communication to the smartphone, restaurant staff member calling out the name of the customer or a number which the customer was allocated when he placed his order, or by other equivalent mechanism. As the self-order customer has, as part of his using the self-order process, generally provided an email address and the IMEI number of his phone, the CQC arrangement can send a note to the smartphone advise of order ready status if the service is collection based.

The steps 319 and 321 are associated with respective delay parameters dᵥₒ and d_{vq} these respectively representing the delay incurred in placing the order by smartphone, and the delay incurred in waiting in the virtual queue.

The delay d_{vq} incurred by waiting in the virtual queue associated with the step 321 is approximately (allowing for the presence of dᵥₒ) equal to current total composite queue delay d_{cq} which is incurred by the physical line customer waiting in the physical line associated with the step 305. This is because physical line customers waiting in the physical line and self-ordering customers waiting in the virtual queue are in all fact waiting in the composite queue and are served according to the composite queue. The equality of delay parameters emphasizes the fairness of the CQC arrangement which ensures that whether a customer places his order electronically by smartphone or stands in a physical queue he will wait a time which is not disadvantageous or advantageous in regard to customers who elect other methods of queuing.

In other words, whether the customer self-orders, or stands in a line, or even waits for table service, the customer will be served on the basis of his position in the composite queue which reflects a priority of order acceptance based on the arrival time of the customer.

A distinct advantage of the CQC arrangement is that customers can be advised of the expected delays, and can be updated if these expected delays change. More particularly, if an additional delay is identified, customers can be advised thereof in order to prevent or ameliorate any irritation which might otherwise arise. Furthermore, if expected delays decrease, for example because of a shift change in the kitchen involving additional kitchen staff, customers can be advised thereof which would create a positive reaction, possibly adding to the reputation of the establishment.

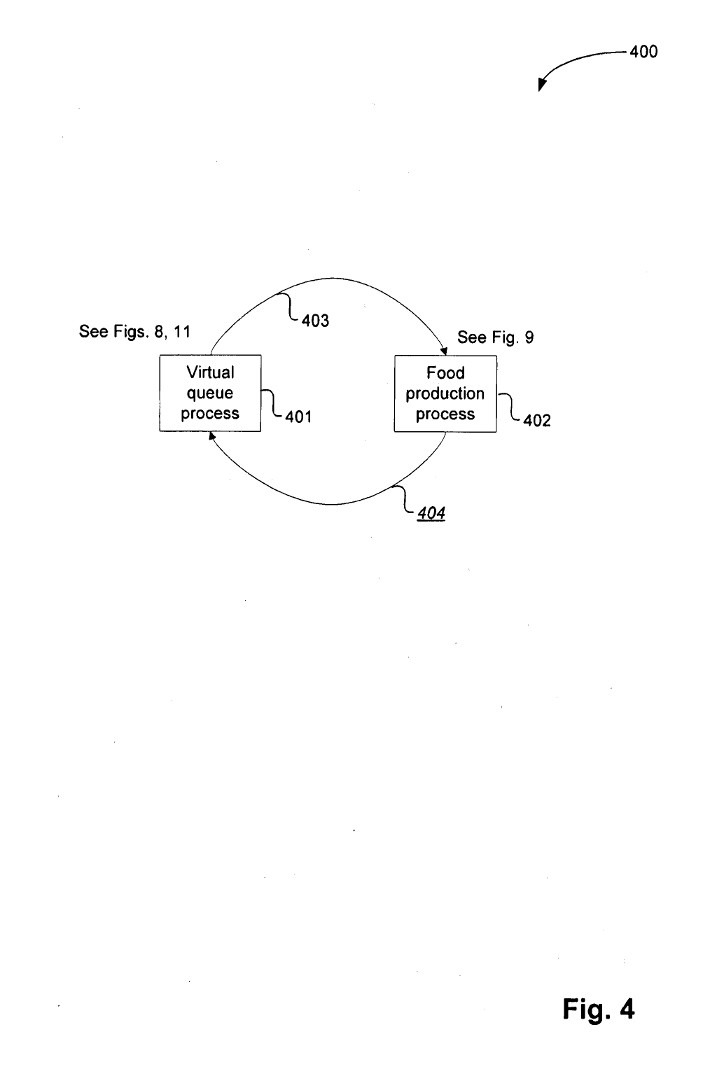

As described hereinafter in more detail with respect to FIGS. 4-8, the CQC arrangement allows the server 109 (or the Maitre-de (restaurant manager) in a manual implementation) to virtually place the next electronic order at a point in the physical queue. For example, if the physical queue 120 contains ten customers and the new customer 126 arrives and immediately takes a table and self-orders, the CQC arrangement prevents the new customer from jumping to the front of the queue and taking the next place in the production line. To ensure that this does not occur the server 109 (or the Maitre-de in a manual implementation) can set a parameter that allows the new customers order to be placed in the composite queue based on a determined speed of service parameter dₛₛ (eg see 501 in FIG. 5). In this example the server 109 or the manager can set a current total composite queue delay d_{cq} based upon 8 people with an inter-person delay dₛₛ of 90 seconds, resulting in current total composite queue delay d_{cq} of 12 min. Although the order is processed by the CQC arrangement and payment is taken immediately from the customer 126, the back of house will not receive the order docket until 12 min after the payment is processed. This CQC arrangement blends the physical and virtual queues by placing each new self-order into the physical queue to form the composite queue, and steps every subsequent order to emulate the physical constraints of queuing, order processing and kitchen capacity

FIG. 4 depicts two “back of house” processes 401 and 402 which interact in an ongoing manner in the CQC arrangement, as depicted by arrows 403, 404. The virtual queue process 401 (described hereinafter in more detail in regard to FIGS. 5-8) and the food production process (described hereinafter in more detail in regard to FIGS. 9 and 10) operate in an ongoing continuous manner as depicted by the arrows 403 and 404. This depiction is illustrative, and serves to show that the virtual queuing process 401, which has an effect in the front of house on the delay experienced by customers in the composite queue, affects and is affected by the food production process 402, which occurs in the back of house, and which relates, among other things, to congestion experienced at the cooking areas in the kitchen 101.

FIG. 5 shows an illustrative depiction 500 of how the composite queue is formed from physical line customers standing in the physical line 120 and self ordering customers waiting in the virtual queue, an example of such a customer being the customer 122 in FIG. 1.

FIG. 5 shows, as a starting point for the description, a number of customers P₁, P₂, P₃, . . . Pₙ who are standing in the physical line 120 (see FIG. 1) in respective timeslot positions. The customers P₁ and P₂ (having respective time slots 129 and 130) occupy their respective time slots, in terms of the time at which they are served by the manual register 118. The time slot 130 associated with the customer P₂ is delayed by a parameter dₛₛ with respect to the time slot 129 associated with the customer P₁. The parameter dₛₛ is a speed of service parameter which represents the delay between the time the customer P₁ in the time slot 129 places his order at the manual register 118, and the time the customer P₂ in the time slot 130 is expected to do the same at that register.

The customer Pₙ standing at the back of the physical line and allocated to the timeslot 504 expects a total composite queue delay d_{cq} depicted by an arrow 502 before he or she will reach the manual register 118 in order to give his order. The time slots 129, 130, . . . , 504 presently assigned to customers are referred to as active time slots. A new customer V₁ (i.e., 507) then places her order electronically, in the same manner as the customer 122 in FIG. 1. The queue management server 109, controlled by the CQC application software program 233, allocates, as depicted by an arrow 508, the new customer V₁ to a first time slot 507 defined by a dashed outline 505 and a speed of service delay 506 behind the customer Pₙ in the timeslot 504 which is presently the last active time slot in the current composite queue. This allocation forms a new composite queue as depicted in FIG. 6, in which the latest customer V₁ is now situated at the “end” of the composite queue, in a time slot 505 with a delay of dₛₛ behind the time slot 504 associated with the customer Pₙ. The aforementioned allocation of the customer V₁ in the composite queue can be performed automatically, manually or using a hybrid manual/automatic approach within the CQC arrangement.

Importantly, this ensures that the new customer V₁ (ie 507) in FIG. 5 is placed into the composite queue at the same delayed time instant that a physical customer would have been placed behind the then-last customer Pₙ, without imparting any unfair advantage or disadvantage to the customer V₁.

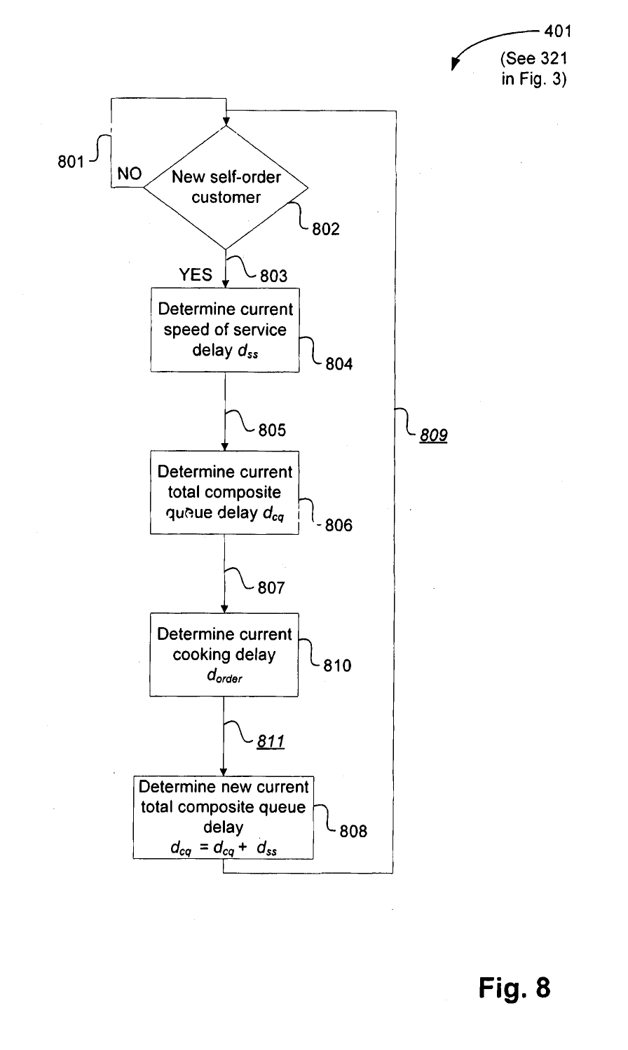

As described hereinafter in regard to FIG. 8, the construction of the composite queue treats each customer, whether they are a physical line customer or a self-order customer, in the same manner, spacing the customers in time slots spaced apart from each other by delays of dₛₛ.

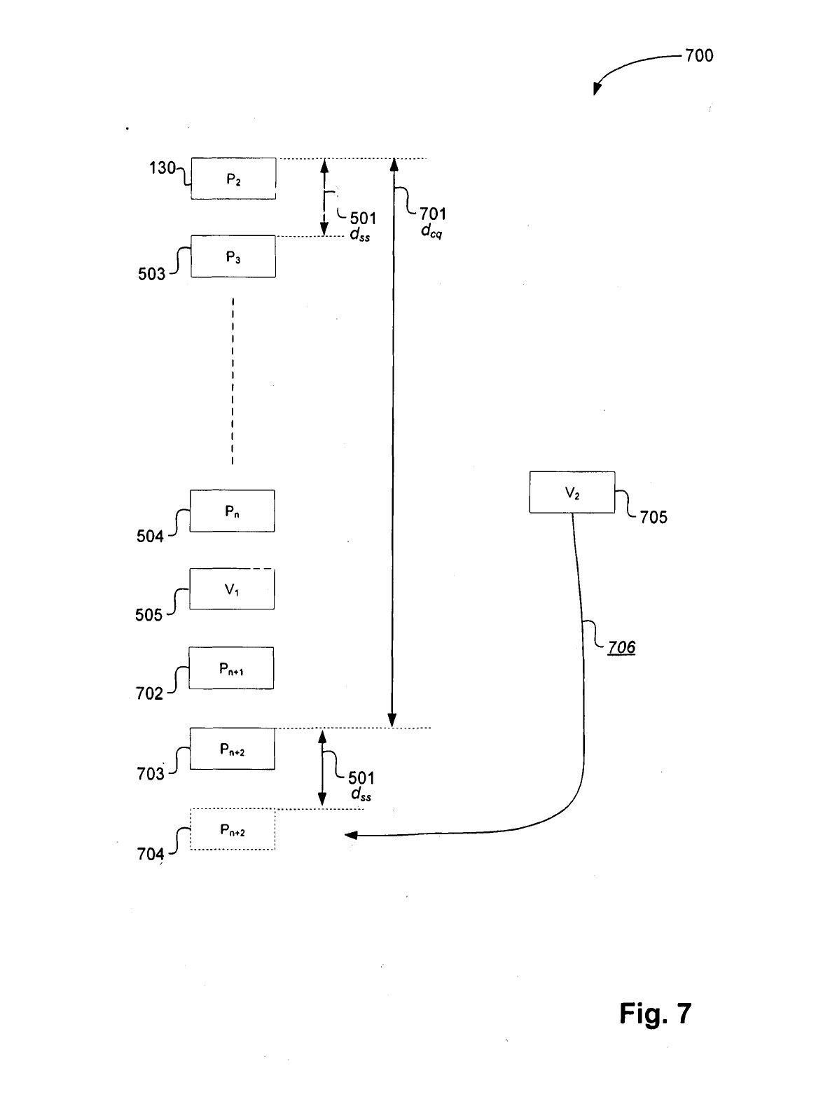

FIG. 7 depicts the composite queue some time later when the first customer P₁ (in the time slot 129) in FIGS. 5 and 6 has been served. The customer P₂ (in the time slot 130) is now at the front of the composite queue being served by the manual register 118. In the time that has elapsed since the time associated with FIGS. 5 and 6, two new customers have joined the physical queue 120, these customers being labeled Pₙ₊₁ and Pₙ₊₂ (having associated timeslots 702 and 703 respectively). A new customer V₂ (i.e., 705) self-ordering by smartphone, is allocated, as depicted by an arrow 706, a time slot 704, which is one speed of service parameter delay 501 behind the last customer Pₙ₊₂ in the composite queue.

In practical situations, the vagaries of people moving in and out of the physical queue are unpredictable. The CQC arrangement takes account of this by keeping the next virtual order to be placed at the same starting position in the composite queue plus the minimum time difference (dₛₛ) between orders. If the time between virtual orders is greater than dₛₛ then the next virtual order is placed at the defined starting position. So, for example, if dₛₛ=90 sec and two people Pₙ₊₂ and Pₙ₊₃ join the physical queue to order within a 90 sec period, and if then V₂ ordered during the same 90 sec period, then V₂ would actually be ahead of Pₙ₊₃. The issue is always how many people join the physical queue over any short period and how the CQC arrangement caters for that. If queue length is monitored continuously, for example using cameras and face/feature recognition, then it would be possible to add a delay dₛₛ for every new Virtual order (placed by a self-order customer) to the composite queue. In another arrangement, the CQC arrangement parallels the physical queue and then slows both queues at the same rate so as to control kitchen capacity. The composite queue only really comes into effect when the order is placed to the kitchen.

At any point in time, the current total composite queue delay d_{cq} is determined by the number of customers standing in the composite queue, whether these are physical customers or self-order customers having placed their orders by smartphone, each separated by a time delay equal to the current speed of service delay dₛₛ.

FIG. 8 shows a flowchart for a process 401 which is one example of how the composite queue construction depicted in FIGS. 5-7 can be performed. Another example is described in regard to FIG. 11. In the examples described herein, there is always a single composite queue, noting that processing of the composite queue can be performed either sequentially or in parallel. Although multiple composite queues can be used, this is typically limited to situations where there are effectively different restaurants operating in parallel, such as would be the case in a large stadium with separate areas designated as separate “restaurants”.

The process commences with a decision step 802 which determines if a new customer, self-ordering or physical line (such as the customer 122 and the customer 130 respectively in FIG. 1), is placing a new order or joining the physical line. Detection of new self-ordering customers can be performed by the CQC software 233 executing on the server 109. Detection of new physical line customers joining the physical line can be performed manually or automatically using cameras and pattern recognition software.

If the step 802 returns a logical FALSE value, then the process 401 follows a NO arrow 801 back to the step 802. If, on the other hand, a new customer is on the scene, then the process 401 follows an arrow 803 (i.e., YES), to a step 804. In the step 804 the queue server 109 (or the restaurant manager) determines the current speed of service delay dₛₛ. This speed of service parameter reflects the average speed d_{c} at which meals are being completed in the back of house, and is determined by the available production space, the current orders in production and their cook time (including capacity delays d_{order}) and the speed at which new orders are being received. Various approaches to determining dₛₛ are described herein in more detail with reference to FIG. 11 and in the section entitled “Automated control of queuing delays”.

The process 400 then follows an arrow 805 to a step 806 in which the server 109 determines the current total composite queue delay d_{cq} as depicted by 701 in FIG. 7. This total composite delay is equal to the number of customers, be they physical customers in a physical line such as 120 or customers having self ordered by smartphone, multiplied by the current speed of service delay dₛₛ between the time slots associated with each of the customers. Thus, for example, in FIG. 7 the current total composite queue delay d_{cq} before the new customer 705 is allocated a slot in that queue is equal to the number of customers in the composite queue (this being n+1) multiplied by the speed of service delay in between each pair of customers, this being dₛₛ.

The process 400 then follows an arrow 807 to a step 810 in which the server 109 determines d_{order} which is an unexpected cooking delay occurring in back of house, described hereinafter in more detail in regard to FIG. 9.

The process 401 then follows an arrow 807 to a step 808 in which the queue server 109, if the new customer is a self-order customer, inserts the new customer into the composite queue and determines the new current total composite queue delay, this being equal to the previously current delay 701 plus the added speed of service delay 501. If the new customer is a physical line customer joining a queue such as 120, then in the step 808 the queue server 109 determines the new current total composite queue delay, this being equal to the previously current delay 701 plus the added speed of service delay 501. The process 401 then follows an arrow 809 back to the step 802.

The effect of the process 401 depicted in FIG. 8 is to continuously construct a composite queue including customers standing in physical queues such as 120 and customers electing to self order by smartphone such as the customer 122, each customer being allocated a time slot in the queue according to the process 401, and each customer being separated from those in front and behind him or her by the speed of service delay dₛₛ at the time.

As the back of house processes speed up and slow down according to the load and other factors such as staff fatigue etc., the speed of service delay dₛₛ (ie 501) between the time slot associated with each customer in the composite queue can be adjusted, so that the front of house processes accommodate changes in the back of house processes to thereby avoid congestion and uncontrollable delays.

FIG. 9 depicts the process 402 from FIG. 4 in more detail. The process 402 commences with a step 924 which determines the current load states of all the cooking areas such as 105 in the kitchen 101. These load states reflect the capacity of each cooking area to accommodate a new incoming order.

In any restaurant there is a wide variety of meals available. Each meal has a minimum cooking and preparation time. When ordering, to ensure that all meals are delivered at the same time they must all be prepared based on the slowest meal cooking time. For example, if four people order meals, three of which are chicken or fish and one is a well done steak, the time to deliver the four meals is the time it takes to cook the well done steak as this is the slowest item in the production queue. The data for this parameter is set based on the venues known cooking and preparation times per item and is not variable during operation but must be set by the CQC arrangement as a fixed parameter.

In a production kitchen such as 101 there are a multitude of production stations (also referred to as cooking areas such as 105). Each station has its own controls and timing parameters based on the menu in place, and each area is limited in its production capacity and speed to deliver by the size of the station and the skill of the operator. For example, a grill may only be able to cater for 20 steaks at any one time being cooked. If, due to the vagaries of customer demand, there is a high number steaks on order this slows down all foods that need to be cooked on the grill. Furthermore it delays ALL orders that require any single item to be cooked on the grill. A settable variable parameter allows the server 109 or the back of house operator (eg the Sous Chef) to setup a delay on any one or multiple stations. This is an additional delay that is added to delivery times when any area is at full capacity. In the above example the Sous Chef would place a delay on the grill of X minutes to allow the station to keep working without the need to attempt to resolve demand issues. This in effect ensures customer satisfaction because the total delivery time is known and provides consistency of quality as there is no necessity to cater for uncontrollable levels of demand for service

The extent to which the step 924 can accurately determine the current load states of all the various cooking areas depends, among other things, upon the relative number of orders that are taken by self-ordering, and the number of orders that are taken by the manual registers such as 118. This is because, for example, an order placed by a self-ordering customer by smartphone for a steak reaches the relevant cooking area such as 105 in the kitchen in a time which is defined by the communication processes in the CQC arrangement within fairly tight bounds. In contrast, an order taken via the manual register 118 can, in some circumstances, be handwritten on a paper docket which is then transported physically to the appropriate cooking area such as 108 in the kitchen 101.

The CQC arrangement does not have as precise a knowledge of the time at which the manually order steak is placed on the stove in the cooking area 105 as it does for the steak which is self-ordered. Furthermore, in some CQC arrangements, the question of whether a particular steak is almost ready may be assessed by a chef for orders which have been placed manually, and may be tracked by the CQC system in terms of a time delay for steak which have been ordered electronically. This type of uncertainty, coupled with other types of uncertainty associated with the hybrid nature of the CQC arrangement, means that the determination of current load states of all the cooking areas in the step 924 may vary in precision depending upon the particular configuration used in the restaurant 100 and the proportion of customers who are self-ordering or standing in queues to be served.

It is also noted that the step 924 may, in some circumstances, be performed automatically by the server 109 under the control of the CQC software application 233, but in other circumstances may have a manual component, this being effected by a chef in the back of house. Similar comments apply to many of the steps in the process 402 and other processes in this description.

The process 402 then follows an arrow 923 to a step 901 which, in relation to a current order, identifies the item in that order which will take the longest to prepare. Thus, for example, if an order is placed by four people together, each of these people ordering their own meal, where three of these are for chicken or fish and one is a well-done steak, then the steak meal will be the order item which will take the longest to prepare. As for the step 924, orders which are received electronically can be processed by the management server 109 which can identify the slowest item, whereas orders which are received manually at the manual registers such as 118 may require human intervention to identify the slowest item.

The process 402 then follows an arrow 902 to a step 905 which identifies the cooking area associated with the aforementioned slowest item, and identifies the current load state of that cooking area. Following an arrow 904, a following decision step 906 determines whether any cooking area will be overloaded as a result of the current order. This will occur when a load state of a relevant cooking area in the kitchen varies from a pre-determined load state by more that a first threshold amount. If this is not the case, then the process 402 follows a NO arrow 907 to a step 908 which processes the current order without any delay. Clearly, since no overload conditions will be encountered as a result of the current order no adjustment is required in the back of house to accommodate the order, and also there is no need to change any parameters in the front of house as a result of such delay.

The process 402 then follows an arrow 903 to a decision step 916 in which the server 109 and/or a sous chief determines whether a change in the front of house service speed or added delay advice to any production area is called for. Thus, for example, if congestion has slowly been building up in the kitchen 101, it may be advisable to slightly slow down the speed at which customers are being served in the front of house in order to introduce a margin of safety into the kitchen production scheduling. Alternatively, if the capacity at which the kitchen is operating is slowly dropping, then it would be advantageous to increase the speed of service in the front of house in order to bring the kitchen load back closer to its optimal level. The step 916 can operate, for example, by determining whether the load state of one or more cooking areas 105 exceeds a pre-determined second threshold by a particular amount.

Returning to the step 916, if the step determines that a change in the front of house service speed is called for, the process 402 follows a YES arrow 920 to a step 921 which changes the front of house speed of service, as described hereinafter in more detail with respect to FIG. 10. The process 402 then follows an arrow 922 back to the step 924. Returning to the step 916, if no service speed change is required in the front of house, then the process 402 follows a NO arrow 917 from the step 916 back to the step 924.

Returning to the decision step 906, if the step determines that one or more cooking areas will be overloaded by the latest order, the process 402 follows a YES arrow 909 to a step 910. The step 910 determines an increment to the speed of service delay dₛₛ, the increment being referred to as a cooking delay parameter d_{order}, which reflects a delay, this being an unexpected delay, in food preparation which will shortly be evident in the front of house. The unique advantage of the CQC arrangement is that this delay can be communicated to the front of house customers, thereby informing them of the state of play in the back of house, in order to reduce or even eliminate any irritation which might arise by having their orders arrive late.

Accordingly, the process 402 follows an arrow 911 to a step 912 which determines whether the current order being considered by the step 901 is from a self-ordering customer or from a customer standing in a physical line. If the current order is from a self-ordering customer then the process 402 follows a YES arrow 925 to a step 918 which advises all relevant self-ordering customers about the delay. For a self-ordering customer, precise delay information is available, on a per-order basis. The delay may be advised to the self-ordering customer in any convenient format, including for example a new estimated time to service d_{sq}′ or a delay d_{order} from a previously indicated estimated service time. However, the precision of the information provided to the customer is typically a bit more general, so as not to unnecessarily raise expectations. The feedback approaches adopted to keep customers informed are as much about managing customers expectations as they are about controlling system flows. The step 918, which can be performed by the server 109, advises the self-ordering customer associated with the current order, and may also advise a number of self-ordering customers further down the composite queue that they should expect delays, this decision depending upon the expected time before the delay will be reversed. The process 402 then follows an arrow 919 from the step 918 to the step 916.

Returning to the step 912, if the current customer is not a self-ordering customer, then the process 402 follows a NO arrow 913 to a step 914. This step 914 advises the current customer standing in the physical line 120, for example, and relevant subsequent customers in the composite queue about the delay. For a physical line customer, precise delay information is not available. However, even a general delay indication provided to the customer provides a beneficial effect. In a similar manner to the step 918, the number of customers advised about the delay depends upon the size of the delay and the expected resolution time after which the delay will be removed.

FIG. 10 shows a flowchart for the process 921 in FIG. 9. The process 921 commences with the arrow 920 from the step 916, this being directed to a decision step 1001. The decision step 1001 determines whether to change the number of registers in the set 116 of manual registers. Thus, for example, if it is desired to speed up the taking of orders in the front of house, additional registers may be added, provided of course that these are available. On the other hand, the number of presently operating registers may be decreased if it is desired to slow the taking of orders.

If the step 1001 determines that the number of registers is to be changed, the process 921 follows a YES arrow 1002 to a step 1003 which determines the desired number of registers. Thereafter, the process follows an arrow 1004 to a step 1005 which changes the number of registers accordingly, by advising the relevant staff to either shut-down their registers after serving a certain number of customers in the line 120, if the number of registers is to be decreased, or to open additional registers in order to increase the number of registers operating. The process 921 then follows an arrow 1006 to a decision step 1007. Returning to the decision step 1001, if the number of registers is not to be changed, then the process 921 follows a NO arrow 1013 to the step 1007.

The decision step 1007 determines whether, in respect to each of the presently operating manual registers such as 118, the operating speed per register is to be increased. This determination is predicated upon the presumption that staff at the manual registers have a target processing speed which may be varied either up or down depending upon instructions from the back of house. If the step 1007 returns a logical YES, then the process 921 follows an arrow 1008 to a step 1009 which determines the desired processing speed per register, after which the process 921 follows an arrow 1010 to a step 1011 which changes the speed of each register accordingly by advising the relevant staff member of the appropriate processing speed. The process 921 then follows an arrow 1012 to the arrow 922 which is directed to the step 901 in FIG. 9. Returning to the step 1007, if the step determines that the speed of processing at the registers is not to be changed, then the process 921 follows a NO arrow 1014 to the arrow 922 and from their to the step 901 in FIG. 9.

Depending on kitchen size, the number of cooking, storage and preparation areas means that the number of orders that can be taken in any period is fixed. At front of house the speed at which orders are taken is controlled by the number of terminals in use and the speed that each operator will process an order. However to cater for limitations in the kitchen, the CQC arrangement will add or remove terminals and advise operators to slow down order processing to allow the kitchen to cope. This delays the service and increases the physical queue and the associated waiting time. When adding a self-order capability, the speed at which any order is processed must cater for the capacity capabilities of the kitchen in which it operates and allow for other operators in the system. As the self-order element is electronic it can take multiple orders all within seconds of each other. The frequency with which these orders reach the kitchen need to be controlled to avoid creating chaos in the kitchen. The CQC arrangement controls the speed of service in front of house according to kitchen capacity.

For example a standard delay dₛₛ of 90 seconds typically matches the food preparation delay in a kitchen 101. Although two, three or more orders can in be placed simultaneously by self-ordering customers, orders are actually sequentially processed in the CQC arrangement. Thus inserts a delay dₛₛ between the first and second order, and so on. Any orders placed within the 90 sec parameter are delayed to the 90 second point and each subsequent order is delayed to the next 90 sec point. Typically, dₛₛ falls between 20 and 120 seconds.

From a physical perspective the order placement delay dₚₒ (see 307 in FIG. 3) can assume a value between a maximum and a minimum due to customer satisfaction, communication and data entry speed. The self-order approach has no such problem as it just provides a total time to order hiding these small variances. Increasing or decreasing registers speeds up or slows down dₛₛ which dictates the speed at which orders are delivered to the kitchen. So, for example, 2 tills (registers) with a dₛₛ of 90 secs equates to an order delivery time of 45 secs in the kitchen. Add in self-order customers according to the CQC arrangement, with a dₛₛ of 90 secs and this is now 30 secs between orders. So the speed at which food is being served up out of the kitchen needs to be at a rate of one set of meals (1 to 8 covers) every 30 seconds when the kitchen is at capacity. When the kitchen is NOT at capacity then so long as it is not going to reach capacity it can keep taking orders every 30 secs. Flexing (varying) dₛₛ then allows for the completion of orders at a rate that is faster than the kitchen receives them.

FIG. 11 shows a flowchart for another example process for constructing the composite queue. The process commences with a decision step 1102 in which the server 109 determines if a new self-order customer has come onto the scene. If this is not the case, then the process follows a NO arrow 1101 back to the step 1102. If, on the other hand, a new self-order customer is in place, then the process follows a YES arrow 1103 to a step 1104. In the step 1104, the server 109 determines the current speed of service delay dₛₛ. The process then follows an arrow 1105 to a decision step 1106, in which the server determines whether the time between orders dᵥₜ is >dₛₛ. If this is the case, then the process follows a YES arrow 1107 to a step 1108. In the step 1108, the server 109 defines the standard service time parameter d_{fs} to be equal to the current value of that parameter. The process then follows an arrow 1106 to a step 1113.

Returning to the decision step 1106, if the step returns a logical FALSE value, then the process follows a NO arrow 1110 to a step 1111. In the step 1111, the server 109 defines the standard service time parameter dₛₛ to be equal to the time between orders, i.e. dᵥₜ. The process then follows an arrow 1112 to the step 1113. In the step 1113, the service determines the current total composite queue delay d_{cq}. The process then follows an arrow 1114 to a decision step 1115. The step 1115 determines whether any item in the current order has an order delay d_{order} which is greater than “0”. If this is the case, then the process follows a YES arrow 1119 to a step 1120. In the step 1120 the server 109 determines the longest food delivery time, by comparing the largest cook time d_{c} to d_{c}+d_{order} of the item associated with the cooking delay d_{order}. The process then follows an arrow 1121 to a step 1122. Returning to the decision 1115, if the step returns a FALSE value, then the process follows a NO arrow 1116 to a step 1117. In the step 1117, the server 109 determines the longest cook time by comparing the cooking delay d_{c} of all the items in the present order. The process then follows an arrow 1118 to the step 1122.

In the step 1122 the server determines the estimated time to service d_{sq}. The process then follows an arrow 1123 to a decision step 1124. In the step 1124 the server determines whether the estimated time to service d_{sq} is greater than the current total composite que delay d_{cq} plus the cooking delay d_{c}. If this is the case, then the process follows a YES arrow 1128 to a step 1101. In the step 1101 the server advises the operator to increase the value of the standard service time parameter dₛₛ.

The process then follows an arrow 1129 back to the step 1102.

Returning to the decision step 1124, if the step returns a logical FALSE value, then the process follows a NO arrow 1125 to a step 1126. In the step 1126 the server maintains the value of the standard service time parameter dₛₛ. The process then follows an arrow 1127 back to the step 1102.

Each cooking area such as 105 has a fixed capacity in terms of items that can be cooked at any one time. Some items have variable cook times (eg steaks) while other items have fixed cook times. In the case of fixed cook times, each item is prepared within a small window of time variability, based on the skill of the operator. Orders placed up to the maximum capacity of the cooking area all have the same cook times. When the cooking area reaches it maximum capacity, a delay d_{order} is determined (eg see 906 and 910 in FIG. 9) this being the time required to clear the first order that has been placed into the cooking area in question, which is also the time required to create space for the next order to start cooking (ie it is a First In First Out FIFO system).

The more orders that are received in the cooking area when it is at maximum capacity, the larger d_{order} must become. When d_{order}+d_{c}>d_{c} (for the longest cook item in the current order) then dₛₛ must increase (see 916 in FIG. 9). Where there is a variable cook time (such as steak and sometimes lamb) the same logic applies. Where there is available space there is no load issue, but when there is no space the calculation is based on the time to the next available space which may be a rare steak rather than the first steak on which may have been a well done steak (i.e. it is not FIFO).

Estimating this is complex, and the chef skill is critical in manual arrangements. In a manual system the Chef flexes both dₛₛ and d_{order} by cooking area using a tablet interface. An automated system considers all items on the cooking area, determines d_{c} for all items in the order, and then uses the shortest d_{c} time to estimate the next available cooking space. This creates a constantly changing d_{order} based on the types and quantity of orders in place. Accordingly dₛₛ could flex (ie vary) dramatically. However, this is managed based on averages of meal types served in a setting per period of day.

A number of system examples, together with associated parameter values, are set out below.

### SYSTEM EXAMPLE 1

### Present Restaurant State

No customers are in the Physical queue; ie d_{pq}=0

All cooking areas clear; C_{aq}ⁿ=0 for all n (where C_{aq}ⁿ refers to the number of orders being processed by cooking area no n)

### First Order Received by Virtual System

dₛₛ=20 sec (min value)

d_{cq}=(Pₙ×dₛₛ)+dₛₛ=0+20 sec

d_{order}ⁱ=0 for all i

d_{c}=longest item cook time

d_{vq}=d_{c}+d_{order}+dₛₛ

d_{vq} is advised to customer

No change to dₛₛ

### SYSTEM EXAMPLE 2

### Present Restaurant State

Pₙ=5

dₛₛ=20 sec

C_{aq}ⁱ=10 (no delays) for all i

### Order Received by Virtual System

d_{cq}=(Pₙ×dₛₛ)+dₛₛ=5×20+20=120 sec

d_{order}ⁱ=0 for all i

d_{vq}=d_{c}+d_{order}+120 sec

No change to dₛₛ

### SYSTEM EXAMPLE (EXTREME) 3

### Present Restaurant State

Pₙ=10

dₛₛ=60 sec

C_{aq}¹=40 max (the number of orders being cooked on cooking area no 1 is 40 which is the maximum for that area)

C_{aq}ⁱ=10 for all other I (ie the number of orders being cooked on all the other cooking areas is 10 which is less than the maximum capacity of those stations)

### Order Received by Virtual System for Item at C_{aq}¹

d_{cq}=(Pₙ×dₛₛ)+dₛₛ=10×60+60=11 min

d_{order}¹=240 sec, d_{order}ⁱ=0 for all other i

d_{vq}=d_{c}+d_{order}¹+11 min

d_{vq}>d_{c}+d_{cq} therefore dₛₛ increases

System example 1, 2 and 3 above represent situations in which the environment being managed is a restaurant where service is controlled in order to ensure that a small kitchen operates smoothly (except for C_{aq}¹=40) which is an unusually high volume example for this type of restaurant.

In a high volume environment the CQC arrangement operates as follows.

### 1—Considering the Physical Queue Customers

As an example at the start of service there are no people in the queue and therefore only 1 service point (eg the register 118) is operating to take orders. The average order speed dₛₛ is roughly constant, but dₛₛ varies based on the nature of each order and the human interaction. Large orders can take minutes, small orders can take seconds (e.g. dₛₛ ranges from 20-120). The speed of orders flowing into the kitchen is irrelevant as there is no capacity constraint.

Over time a queue may form as demand increases. However with only one service point and a large kitchen with a variety of cook areas C_{aq}ⁱi=1,n there is little risk of capacity congestion in the kitchen and more likely the queue will expand rapidly.

To alleviate the queue and increase utilization of the cooking area a second service point 134, and possibly even more service points (ie registers) are added to a maximum of n registers. Increasing the number of registers has the effect of increasing the service speed in an almost linear fashion. This is because the person P₁ is served by a register S₁ (a server operator operating the register) and P₂ by S₂ until Sₙ is reached. The effect of adding service points is to speed up the number of orders going to the kitchen, or in other words reduce the delay between orders going to the kitchen, this delay being defined by dₛₛ. The aforementioned speed up effectively reduces dₛₛ by dividing dₛₛ by the number of operational services points Sₙ.

The variability of orders being taken dictates that dₛ is not consistent between registers or between orders placed by people Pₙ. Thus for example if three registers are operating, it may be that the actual speed of orders submitted is faster than the kitchen would like, and thus the actual dₛₛ/3 does not equal the calculated dₛₛ/3. This variability also means that if there is no controlled single line queue, then customers at any service point (register) could be being served faster than estimated according to dₛₛ because of the skill of the register operator and/or the order of customers Pₙ and the composition of their orders.

Furthermore, in a parallel register situation, order entry into the kitchen is not necessarily sequential according to the ordering in the composite queue. If in the three register situation the person P₂ orders a single product vs P₁ ordering 5 meals and P₃ ordering 4 meals, all the meals having difficult variations, it is assumed according to the single composite queue that the order P₂ will enter the kitchen prior to P₃ and P₁. It may also occur then that P₄ (in a controlled single queue waiting for a register) may also have their order sent to the kitchen prior to P₁ and P₃ if the order for P₄ is also simple.

In practical terms this means that in a single line controlled queue the position of any order Pₙ being delivered to the kitchen is not truly linear, because there may be parallel service points. When the kitchen starts to reach capacity of cooking space, one of three things occurs in the CQC arrangements:
1. The number of servers (registers) is reduced from n to n−r therefore reducing dₛₛ/n to a new value dₛₛ/(n−r) (where r=a server reduction number)
2. Servers (ie register operators) are advised to slow down service speed, and thus dₛₛ is increased;
3. Both of the above occur and dₛₛ is increased to dₛₛ/(n−r)

This results in the potential lengthening of the queue or queues, but keeps the kitchen operations at constant and reasonable level as shown in the example depicted in the following table.

Servers 1 to n

| | | | |
|---|---|---|---|
| Server 1 | Server 2 | Server 3 | Server n |

Customer

| | | | |
|---|---|---|---|
| P1 | P2 | P3 | Pn |
| Px | Px + 1 | | |

### 2—Considering the Self-Order Customers

In relation to the self-order customers, the CQC arrangement emulates the variable states of a physical queuing system. For example if there is only one register S₁ then the CQC arrangement can create a virtual second register position S₂, and furthermore can also create a further virtual register position S₃ and so on to Sₙ, based on the timing set up in the CQC arrangement for dₛₛ and the starting point of the initial self-ordering customer V₁.

The CQC arrangement enables a venue to reduce the number of register operators required and therefore reduce labor costs or repurpose them. Practically however it is uncertain how many customers will elect to self-order and how many may choose to enter the physical queue. In practice therefore there will at least at some instances be n registers S₁ to Sₙ in operation. Then CQC becomes Sn+1 that is that if there is both a physical and virtual queue, CQC is setup as the next service point/s.

The self-order processes in the CQC arrangements have their own order delay, being the time it takes a customer to create and enter the order into the smartphone (see 319 in FIG. 3). The system ignores this time and waits until the order is confirmed and then it begins to place the new order into the composite queue.

Since the composite queue is about managing kitchen capacity, the CQC arrangement is unlikely to place this new order in a position associated with the person Pₙ₊₁ (the back of the physical queue) because it needs to emulate the parallel service process of the nth register Sₙ. What will occur is based on the parameters set by dₛₛ and Vₙ. The standard service time parameter dₛₛ will vary based on the speed of all orders being received and will result in the assessment of d_{cq} to modify it. Vₙ being the position that the next new order is placed in line with Pₙ, in acting as a second service point will act as a purely parallel service entity but apply a practical and fair delay to each order to manage the nature of equitable service but importantly keep the kitchen processes moving.

### Automated Control of Queuing Delays

In a hybrid automated/manual CQC arrangement, determination and adjustment of the variables dₛₛ, d_{order} and the time slot in the composite queue into which a new self-order customer V₁ will all be placed are determined on the basis of human skill and experience of the Sous Chef and/or the Maitre De, assisted to varying degrees by automated or semi-automated CQC processes. The aforementioned parameters then control the processes by which orders are received and composite queue created.

In the back of house the Sous Chef can see when any cooking area is in distress (ie congested) and it will adjust timings accordingly, by changing dₛₛ and d_{order}. In the front of house the Maitre De will adjust the parameters to cater for the back of house demand, to thereby speed up or slow down and the need to stagger customer service at a rate that is acceptable to customers.

In a fully automated CQC arrangement the speed of order acceptance will depend on a variety of elements namely:
the number of cooking areas Cₐⁱ
the number of items in a cooking area at any point in time C_{aq}ⁱ, i.e. items that have been ordered (may include items waiting to start cooking)
the maximum number of items any area can cook C_{aq}^{max}
the average percentage of all orders that each area has placed on it Cₚ Cooking percentage; and
the time an item has bees cooking for Cₑₜⁱ Cooking elapsed time

To assess the range of dₛₛ variability the CQC system keeps track of all items currently in the production queue by cooking area Cₐ¹. When any Cₐⁱ reaches a pre determined capacity level threshold (e.g. 70%) the following assessment occurs.

Knowing (a) the number of orders being received over time, (b) dₛₛ, and the average number of orders Cₚ that will impact on the cooking area Cₐ¹ it is possible to calculate the average number of products required. E.g. if dₛₛ=90 secs and the average number of orders for the grill is 25% then on average the grill will receive an order every 6 minutes—dₛₛ/Cₚ.

When any cooking area reaches its first alarm where C_{aq}ⁱ/C_{aq}^{max}>X% (e.g. a 70% threshold) then the CQC system assess all items waiting in the cooking queue Cₑₜⁱ.

If the time to clear the area of the first to finish item or items is slower than the estimated number of orders being received, dₛₛ/Cₚ, then the CQC system must increase dₛₛ or send an alarm to the operator, ie the Sous Chef or the Maitre De. dₛₛ must be increased such that dₛₛ/Cₚ=d_{c}−Cₑₜ¹ where this is the first item to be cleared from the cooking area. Dₛₛ=Cₚ*(d_{c}−Cₑₜ¹)

Similarly when cooking areas Cₐᵢ have a utilization rate that is lower than a predetermined level as calculated above, dₛₛ will be reduced. However as there is no capacity limitation at this point dₛₛ is reduced to its lowest level and then incrementally increased using the above method.

Because orders do not always follow statistical parameters it is possible that any area can be overloaded even with CQC arrangements operating. In such a case d_{order} will be added as a time delay to cook time for all new orders.

When d_{order} is in effect then dₛₛ will need to be calculated as follows:

When C_{aq}ⁿ>C_{aq}^{max} then d_{order}=d_{c}−Cₑₜⁱ⁺¹

d_{order} is the time it will take for a space to be available in the cooking area to begin cooking the current last item plus one in the Cooking queue Cₐ. This is calculated by considering the excess orders allocated to the cooking area and then calculating the time taken to finish cooking the same number of the fastest items in the cooking area.

Thus the next order to be received will wait until there is an available space to begin cooking.

### EXAMPLE

If a production area can manage 20 items all of which have either fixed or variable production times, and there are currently 26 items ordered, the next order to be received must wait until the 7th fastest item to completion (d_{c}−Cₑₜ⁷) in the production area has been completed.

As d_{order} is a capacity limitation, slowing down service speed by increasing dₛₛ will resolve the delay in production. dₛₛ must therefore be calculated as follows:

dₛₛ/Cₚ=d_{order}

ie dₛₛ=d_{order}*Cₚ

### INDUSTRIAL APPLICABILITY

The arrangements described are applicable to the food production and restaurant industries and particularly for high volume establishments.

The foregoing describes only some embodiments of the present invention, and modifications and/or changes can be made thereto without departing from the scope and spirit of the invention, the embodiments being illustrative and not restrictive.

1. A method of controlling ordering and production of food products in a restaurant, the method comprising the steps of:
constructing a composite queue from:
time slots associated with customers standing in one or more physical lines to place their orders at one or more corresponding manual registers; and
time slots associated with customers placing their orders electronically over a communications network; wherein:
the time slots in the composite queue are spaced apart by a speed of service delay; and
an order in the composite queue is sent to a kitchen when the order reaches the front of the composite queue;
determining, in regard to a current order received from a customer being served from the composite queue, load states of at least some cooking areas in the kitchen;
determining whether one of said load states varies from a pre-determined load state by a first threshold amount; and
if said one of the load states varies from the pre-determined load state by the first threshold amount, changing the speed of service delay.

2. The method according to claim 1, comprising the further step of communicating information about the change to the speed of service delay to the customer being served.

3. The method according to claim 1, wherein the constructing of the composite queue
comprises the steps of:
determining a current speed of service delay being dependent upon an average time to prepare the current order in the kitchen;
determining a number of active time slots in the current composite queue, being time slots to which customers have been allocated;
determining a current total composite queue delay dependent upon said number of active time slots in the composite queue and the current speed of service delay; and
allocating a new customer to a first time slot following the last active time slot in the current composite queue.

4. The method according to claim 3, wherein the average time to prepare the current order in the kitchen depends upon a delay associated with congestion of a cooking area where the order is to be prepared.

5. The method according to claim 1, comprising the further steps of:
determining whether one of said load states varies from a pre-determined load state by a second threshold amount;
if said one of the load states varies from the pre-determined load state by the second threshold amount, determining a change to the front of house service processing speed; and
changing the front of house service processing speed by said determined change.

6. A computer implemented system for controlling ordering and production of food products in a restaurant, the system comprising:
a server having a processor;
a memory storing a program for directing the processor to execute a method for controlling ordering and production of food products in the restaurant, the method
comprising the steps of:
constructing a composite queue from:
time slots associated with customers standing in one or more physical lines to place their orders at one or more corresponding manual registers; and
time slots associated with customers placing their orders electronically over a communications network; wherein:
the time slots in the composite queue are spaced apart by a speed of service delay; and
an order in the composite queue is sent to the kitchen when the order reaches the front of the composite queue;
determining, in regard to a current order received by the server from a customer being served from the composite queue, load states of at least some cooking areas in the kitchen;
determining whether one of said load states varies from a pre-determined load state by a first threshold amount; and
if said one of the load states varies from the pre-determined load state by the first threshold amount, changing the speed of service delay.

7. The computer implemented system according to claim 6, comprising the further step of communicating information about the change to the speed of service delay to the customer being served.

8. A server for a computer implemented system for of controlling ordering and production of food products in a restaurant, the server comprising:
a processor;
a memory storing a program for directing the processor to execute a method for controlling ordering and production of food products in the restaurant, the method comprising the steps of:
constructing a composite queue from:
time slots associated with customers standing in one or more physical lines to place their orders at one or more corresponding manual registers; and
time slots associated with customers placing their orders electronically over a communications network; wherein:
the time slots in the composite queue are spaced apart by a speed of service delay; and
an order in the composite queue is sent to the kitchen when the order reaches the front of the composite queue;
determining, in regard to a current order received by the server from a customer being served from the composite queue, load states of at least some cooking areas in the kitchen;
determining whether one of said load states varies from a pre-determined load state by a first threshold amount; and
if said one of the load states varies from the pre-determined load state by the first threshold amount, changing the speed of service delay.

9. The server for a computer implemented system according to claim 8, comprising the further step of communicating information about the change to the speed of service delay to the customer being served.

10. A non-transitory computer readable storage medium storing a computer executable software program for directing a processor in a server to execute a method for controlling ordering and production of food products in a restaurant, the program comprising:
computer executable code for constructing a composite queue from:
time slots associated with customers standing in one or more physical lines to place their orders at one or more corresponding manual registers; and
time slots associated with customers placing their orders electronically over a communications network; wherein:
the time slots in the composite queue are spaced apart by a speed of service delay; and
an order in the composite queue is sent to the kitchen when the order reaches the front of the composite queue;
computer executable code for determining, in regard to a current order received by the server from a customer being served from the composite queue, load states of at least some cooking areas in the kitchen;
computer executable code for determining whether one of said load states varies from a pre-determined load state by a first threshold amount; and
computer executable code for, if said one of the load states varies from the predetermined load state by the first threshold amount, changing the speed of service delay.

11. The non-transitory computer readable storage medium according to claim 10, comprising the further step of communicating information about the change to the speed of service delay to the customer being served.
